(19) United States
(12) Patent Application Publication
(10) Pub. No.: US 2018/0168371 A1
(43) Pub. Date: Jun. 21, 2018

(54) Support Device and Method for Creating Ornamental Arrangements.

(71) Applicant: Thomas J. Francoeur, West Islip, NY (US)

(72) Inventor: Thomas J. Francoeur, West Islip, NY (US)

(21) Appl. No.: 15/382,454

(22) Filed: Dec. 16, 2016

(51) Int. Cl. A47G 7/02; A01G 5/02; A45F 5/00

(52) U.S. Cl. CPC A47G 7/02; A45F 2005/008; A45F 5/00; A01G 5/02

(57) ABSTRACT

A support device and method for the creation of unique ornamental arrangements is disclosed. The support device of the present invention is configured to create a cavity within which an adhesive is contained to facilitate creation of the unique ornamental arrangement. The support device includes an attachment article for securing the unique ornamental arrangement to your person, article of clothing, or an item. The support device is designed for use by individuals of all levels of experience. The present invention increases efficiency and productivity by simplifying the creation of ornamental arrangements through the elimination of traditional wire and taping methods.

### BACKGROUND OF THE INVENTION

### 1. Field of Invention

This invention relates generally to a support device for holding ornamental arrangements and more specifically, to an improved support device and method for creating floral and ornamental arrangements with increased efficiency.

### 2. Description of Related Art

The process by which wearable floral arrangements are created is a time consuming, labor intensive endeavor. Typically, select cut flowers, filler greenery, and ornamental items are precisely placed in an attractive arrangement using varying gauges of wire and floral tape. The completed arrangement may then be pinned directly to an item of clothing or affixed to an attachment device for wearing about the wrist.

While this process has served the floral industry well, the limited resources and demand on a florist's time in creating one-of-a-kind arrangements is such that business must be restricted at peak times of the year. These peak times usually occur when special occasions such as prom, homecoming, and weddings all converge creating a strain on the human capital necessary to produce large quantities of unique arrangements. The strain is further exacerbated simply because these one-of-a-kind arrangements require the expertise of an experienced florist who understands the intricacies of wiring and taping floral, ornamental arrangements.

Therefore, there exists a need for a device and method that increases the efficiency and productivity of creating one-of-a-kind arrangements.

### SUMMARY OF THE INVENTION

The present invention provides for a support device for the creation of an ornamental arrangement. The support device includes a recessed top surface forming a cavity for receiving an ornamental arrangement and a bottom surface configured to receive an attachment article. There are at least two apertures formed in the device for receiving an attachment article. An adhesive may be pre-applied or applied by the end user to the cavity formed by the recessed top surface. The adhesive secures the ornamental arrangement to the top surface of the device.

In some embodiments, the attachment article includes a locking mechanism. The attachment article and locking mechanism may be modular creating interchangeability of the attachment article.

In some embodiments, the support device includes a top surface for receiving an ornamental arrangement and a bottom surface configured to receive an attachment article. There are at least two apertures formed in the device for receiving an attachment article. The top surface may have a thin layer of adhesive pre-applied or may have no adhesive pre-applied. In the latter, a variety of flowers and/or decorative accoutrements of the peel-and-stick variety are supplied for affixing to the top surface of the support device to create an ornamental arrangement. In the former, a variety of flowers and/or decorative accoutrements can be applied directly to the top surface with a pre-applied adhesive that may be exposed by removing a protective layer. The flowers may be fresh cut flowers or artificial. The decorative accoutrements may be those items known to one of ordinary skill in the art that may be included in an ornamental arrangement. For example, the decorative accoutrements may be dictated by the event and include event specific items such as hearts for Valentine's day, etc.

The support device of the present invention is advantageous over the prior art by providing for a device and method that eliminates the need for wiring and taping traditionally required when creating an ornamental arrangement. At peak times of the year, experienced florists can increase their efficiency and productivity. In addition, the present invention allows the inexperienced to create their own unique ornamental arrangements by simplifying the process and tools required. The present invention also allow for unique configurations of the device to create themed ornamental arrangements.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1A illustrates an isometric top view of an ornamental arrangement supporting device according to an embodiment of the invention;

FIG. 1B illustrates an isometric bottom view of an ornamental arrangement supporting device according to an embodiment of the invention;

FIG. 2A illustrates an isometric top view of an ornamental arrangement supporting device according to an alternative embodiment of the invention; and

FIG. 2B illustrates an isometric bottom view of an ornamental arrangement supporting device according to an alternative embodiment of the invention.

### DETAILED DESCRIPTION OF PREFERRED EMBODIMENTS

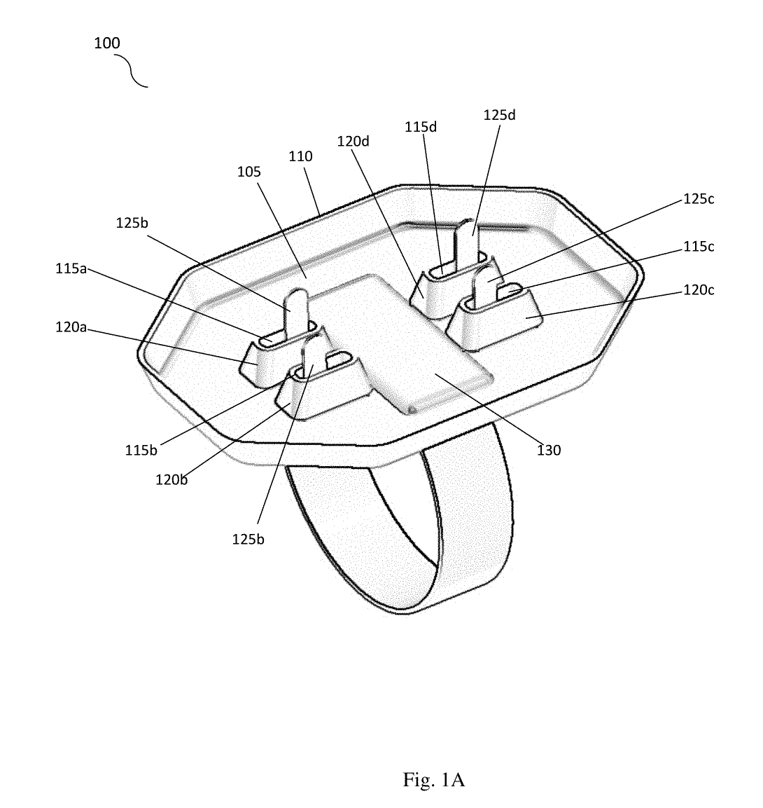

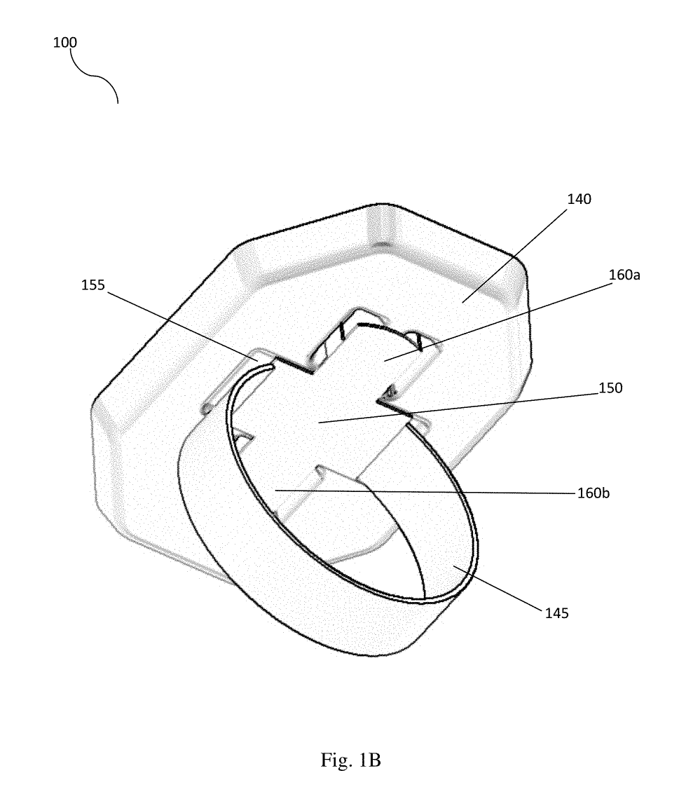

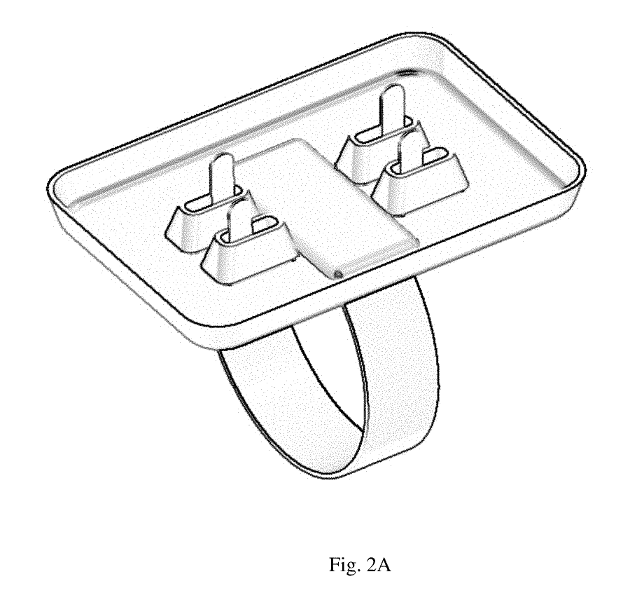

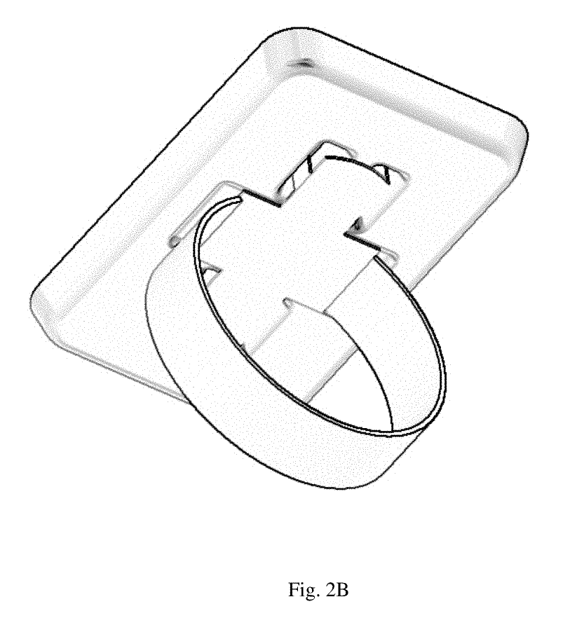

Preferred embodiments of the present invention and their advantages may be understood by referring to FIGS. 1-2, wherein like reference numerals refer to like elements. Although the present invention is described and illustrated in the context of a floral arrangement as applied to a corsage worn about the wrist, it is to be understood that the disclosure of the present invention is not limited to this embodiment but is equally applicable to ornamental arrangements in general, including by way of non-limiting examples, boutonnieres; corsage mums; decorative non-floral arrangements; and of various shapes, sizes, and themes. Additionally, it is to be understood that the support device of the present invention is not limited to attachment to a person or article via a band but by way of non-limiting example may be configured to include a magnet, a pin, clamp, or any other form for affixing to a person or article known to those of ordinary skill in the art.

The support device of the present invention is configured to create a cavity within which an adhesive is contained to facilitate creation of the ornamental arrangement. In an embodiment, the support device is formed from thermoplastics including but not limited to nylon, acrylic, polypropylene, polystyrene, and polyvinyl chloride. In an alternative embodiment, the support device may be formed from hard-pressed cardboard or pressed wood products such as medium density fiberboard or the like. The adhesive may be any adhesive known to one of ordinary skill in the art sufficient to secure floral items as well as decorative accoutrements in a creative arrangement. In an embodiment, the adhesive is a glue including but not limited to pressure sensitive glues such as Catchmaster® Pressure Sensitive Glue. The adhesive may be pre-applied to the support device or may be applied by the end user. If the adhesive is a pre-applied adhesive, a removable protective layer may be included to maintain the integrity of the adhesive as well as prevent unwanted adhesion to unintended items.

In an alternative embodiment, the support device does not include a pre-applied adhesive glue. In this embodiment, the various flowers and/or decorative accoutrements are supplied with a peel-and-stick adhesive for affixing directly to the support device. This is an ideal embodiment for the novice florist and/or avid floral craftsman.

FIG. 1A illustrates an isometric top view of an ornamental arrangement supporting device 100 according to an embodiment of the invention. A top surface 105 of the support device 100 is recessed below the horizontal plane of the top edge 110 such that a cavity is formed to receive an adhesive. At least two apertures are formed in the support device 100 configured to receive locking tabs from an attachment article. For illustrative purposes only, the embodiment of FIG. 1A includes four apertures 115a, 115b, 115c, & 115d formed by protruding channels 120a, 120b, 120c, & 120d configured to receive locking tabs 125a, 125b, 125c, & 125d from an attachment article. The protruding channels 120a, 120b, 120c, & 120d do not extend beyond the horizontal plane of the top edge 110 of the support device 100.

The number and location of the at least two apertures may be dictated by the end-product of the ornamental arrangement. For example, a large ornamental arrangement requiring a larger surface area of the top surface 105 may require more than two apertures to provide sufficient support for the ornamental arrangement about a wrist or other article. A smaller ornamental arrangement consisting of a singular item, for example, may be sufficiently supported by the at least two apertures.

The top surface 105 may also include a protrusion 130 created by a recessed area in the bottom surface (not shown) configured to received an alternative attachment article. In some embodiments, the attachment article is a unitary article with at least two locking tabs configured to removably attach the attachment article to the support device 100. For example, in the illustrative FIGS. 1-2, the wrist band and locking mechanism may be a singular unit. In alternative embodiments, the attachment article may be modular. For example, the locking mechanism may be configured to receive a variety of attachment articles such as an elastic, close-looped band; on open-ended resilient clip; a pinning device; or a spring loaded clamp. In this alternative embodiment, having a modular attachment article allows the user to modify how the ornamental arrangement is displayed or worn. In other words, the attachment articles are interchangeable. For example, the ornamental arrangement may be fitted initially with an attachment device capable of affixing the ornamental arrangement to a pew or a vase for a wedding ceremony. After the conclusion of the ceremony, the ornamental arrangement may be removed from the pew or vase and fitted with a wrist band for wearing by an attendee at the wedding.

FIG. 1B illustrates an isometric bottom view of an ornamental arrangement supporting device 100 according to an embodiment of the invention. The bottom surface 140 is configured to receive a variety of attachment articles as described herein. In the embodiment of FIG. 1B, the attachment article is a wrist band 145. A locking mechanism 150 removably attaches the wrist band 145 to the support device 100 in this embodiment by way of at least two locking tabs (not shown). The locking mechanism 150 is configured to fit within the recessed area 155. The locking mechanism as illustrated in FIG. 1B, includes a perpendicular cross piece with arms 160a & 160b wherein each arm of the cross piece includes the at least two locking tabs (not shown). Those of ordinary skill in the art will recognize that the shape and configuration of the locking mechanism 150 as illustrated in FIGS. 1-2 is for illustration only and not a limiting example to the exclusion of all other alternative embodiments.

FIGS. 2A & 2B illustrates an isometric top and bottom view of an ornamental arrangement supporting device according to an alternative embodiment of the invention. As illustrated in FIGS. 2A & 2B, the support device may be formed into a variety of shapes and sizes to facilitate the creative aspects of the present invention. For example, if a particular shape for an ornamental arrangement is desired consistent with the nature of a particular occasion and/or event, i.e., sporting event or Valentine's Day, the support device may be constructed in the shape of a football or heart to create a particular themed ornamental arrangement.

The embodiment of FIGS. 1 & 2 are illustrative of the present invention whereby thick adhesive glue such as the Catchmaster® Pressure Sensitive Glue is applied to the cavity of the support device. The protruding channels 120a, 120b, 120c, & 120d maintain the integrity of the cavity and prevent seepage of the adhesive glue into the four apertures 115a, 115b, 115c, & 115d.

As described above, there are alternative embodiments including the peel-and-stick alternative. In this embodiment, the support device does not include a top edge 110 as illustrated in FIG. 1. Rather, the support device is essentially flat with no top edge 110 or protruding channels 120a, 120b, 120c, & 120d. Apertures 115a, 115b, 115c, & 115d would be included to facilitate the attachment article as described above. This embodiment facilitates attachment of the ornamental arrangement in two ways. First, the top surface 105 of the essentially flat support device may include a thin coating of adhesive. For example, the thin coating of adhesive may be of the peel-and-stick variety whereby the user would peel away the protective layer to expose the adhesive and build the ornamental arrangement. Second, the top surface 105 of the essentially flat support device may contain no adhesive at all. Rather the ornamental arrangements being applied to the top surface of the support device are of the peel-and-stick variety such that the various flowers and/or decorative accoutrements include a peel-and-stick adhesive. The user would remove the protective layer exposing the adhesive of the various flowers and/or decorative accoutrements and affix directly to the top surface 105 of the support device.

An alternative aspect and advantage of the present invention is the ability of a novice to create unique ornamental arrangements without the hassle of developing a skill set in wiring and taping floral designs. No additional materials are required other than the various flowers and/or decorative accoutrements comprising the arrangement.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A support device for the creation of an ornamental arrangement comprising:
a recessed top surface forming a cavity for receiving an ornamental arrangement and a bottom surface configured to receive an attachment article;
at least two apertures formed in the device for receiving an attachment article; and
an adhesive located in the cavity formed by the recessed top surface;
wherein the adhesive secures the ornamental arrangement to the top surface of the device.

2. The support device of claim 1, wherein the device is comprised of a material selected from the group consisting of nylon, acrylic, polypropylene, polystyrene, polyvinyl chloride, wood, and cardboard.

3. The support device of claim 1, wherein the attachment article includes a locking mechanism for securing the attachment article to the support device.

4. The support device of claim 3, wherein the attachment article and the locking mechanism are modular such that the attachment article is interchangeable with different attachment articles.

5. The support device of claim 3, wherein the locking mechanism includes at least two locking tabs configured to be inserted in the at least two apertures for connecting the attachment article to the support device.

6. The support device of claim 5, wherein the attachment article is selected from the group consisting of a magnet; wrist band; an elastic, close-looped band; on open-ended resilient clip; a pinning device; and a spring loaded clamp.

7. The support device of claim 6, wherein the attachment article is of a unitary construction comprising the locking mechanism, the attachment article, and the least two locking tabs configured to be inserted in the at least two apertures for connecting the attachment article to the support device.

8. The support device of claim 1, wherein the bottom surface includes a concavity formed therein and configured to receive an attachment article.

9. The support device of claim 1, wherein the adhesive is a pressure sensitive glue.

10. The support device of claim 9, wherein the adhesive is pre-applied to the cavity formed by the recessed top surface.

11. A support device for the creation of an ornamental arrangement comprising:
a top surface for receiving an ornamental arrangement and a bottom surface configured to receive an attachment article;
at least two apertures formed in the device for receiving an attachment article; and
a variety of flowers and/or decorative accoutrements for affixing to the top surface of the support device to create an ornamental arrangement.

12. The support device of claim 11, wherein the device is comprised of a material selected from the group consisting of nylon, acrylic, polypropylene, polystyrene, polyvinyl chloride, wood, and cardboard.

13. The support device of claim 11, wherein the attachment article includes a locking mechanism for securing the attachment article to the support device.

14. The support device of claim 13, wherein the attachment article and the locking mechanism are modular such that the attachment article is interchangeable with different attachment articles.

15. The support device of claim 13, wherein the locking mechanism includes at least two locking tabs configured to be inserted in the at least two apertures for connecting the attachment article to the support device.

16. The support device of claim 15, wherein the attachment article is selected from the group consisting of a magnet; wrist band; an elastic, close-looped band; on open-ended resilient clip; a pinning device; and a spring loaded clamp.

17. The support device of claim 11, wherein the top surface includes a peel-and-stick adhesive.

18. The support device of claim 11, wherein the variety of flowers and/or decorative accoutrements include a peel-and-stick adhesive.

19. A method of creating an ornamental arrangement comprising the steps of:
securing selected flowers and/or decorative accoutrements to an adhesive located in a cavity formed by a recessed top surface of a support device;
selecting an attachment article; and
securing the selected attachment article to the support device by inserting at least two locking tabs in at least two apertures formed in the support device.

20. The method of claim 11, further comprising the steps of:
selecting an alternative attachment article; and
securing the selected alternative attachment article to the support device by interchanging with the previously selected attachment article.

21. The method of claim 11, wherein the adhesive is applied to the cavity formed by the recessed top surface by the end user.
